(19) United States
(12) Patent Application Publication
(10) Pub. No.: US 2019/0011920 A1
(43) Pub. Date: Jan. 10, 2019

(54) METHOD AND SYSTEM FOR GENERATING FLIGHT PLAN OF UNMANNED AERIAL VEHICLE FOR AERIAL INSPECTION

(71) Applicant: Sharper Shape Oy, Espoo (FI)

(72) Inventors: Tero Heinonen, Järvenpää (FI); Ville Koivuranta, Helsinki (FI)

(21) Appl. No.: 15/643,547

(22) Filed: Jul. 7, 2017

(51) Int. Cl. G05D 1/00; G06K 9/00; G01M 11/08; G05D 1/10

(52) U.S. Cl. CPC G05D 1/0094; G05D 1/101; G01M 11/081; G06K 9/00637

(57) ABSTRACT

A method for generating a flight plan of an unmanned aerial vehicle (UAV) includes defining a list with at least one asset to be inspected; acquiring structural information of the at least one asset; and defining at least one preliminary inspection-trajectory for the at least one asset. The method further includes acquiring a map with at least one location for the at least one asset and geographical information of at least one region around the at least one asset; mapping the at least one preliminary inspection-trajectory to the location; altering the at least one preliminary inspection-trajectory, to accommodate a safety margin for flight of the UAV, based on the geographical information of the region around the at least one asset; and selecting at least one altered preliminary inspection-trajectory to define the flight plan.

### TECHNICAL FIELD

The present disclosure relates generally to unmanned aerial vehicles; and more specifically, to a method and system for generating a flight plan of an unmanned aerial vehicle for aerial inspection.

### BACKGROUND

In recent times, unmanned aerial vehicles (UAVs) such as drones, are increasingly being used for a variety of real world applications. For example, the unmanned aerial vehicles may be used for applications such as surveillance, aerial inspection, aerial photography, disaster relief operations and so forth. Further, nowadays commercial use of the unmanned aerial vehicles for aerial inspection of geographical regions and asset inspection is prevalent. Typically, asset inspection relates to inspection of valuable assets such as buildings, bridges, electricity pylons, and so forth.

Generally, the unmanned aerial vehicles used for asset inspection are provided with a flight plan before commencement of flight. However, such flight plan may not include specific information about flight trajectory to be followed by the unmanned aerial vehicle, and information about other objects that may be in proximity of the asset. In such instance, the unmanned aerial vehicle may be required to detect such objects in real-time and adjust the flight trajectory accordingly. Further, in an instance of failure (or error) in detection of such objects, the unmanned aerial vehicle may follow an erratic trajectory that may lead to problems such as longer distance of travel, additional time of travel, unnecessary power consumption and so forth. Additionally, the flight plan may not include information about tasks to be performed by the unmanned aerial vehicle during flight. In an instance where the unmanned aerial vehicle does not perform all tasks necessary for inspection of the asset, an additional flight may be required to be performed, further leading to excessive power consumption, longer project completion time and so forth.

Therefore, in light of the foregoing discussion, there exists a need to overcome the aforementioned drawbacks associated with generation of flight plans for unmanned aerial vehicles.

### SUMMARY

The present disclosure seeks to provide a method for generating a flight plan of an unmanned aerial vehicle for aerial inspection. The present disclosure also seeks to provide a system for generating a flight plan of an unmanned aerial vehicle for aerial inspection. The present disclosure seeks to provide a solution to the existing problem associated with generation of flight plans for unmanned aerial vehicles for inspection of multiple assets. An aim of the present disclosure is to provide a solution that overcomes at least partially the problems encountered in prior art, and provides a reliable and easy to implement solution for generating flight plans for unmanned aerial vehicles.

In one aspect, an embodiment of the present disclosure provides a method for generating a flight plan of an unmanned aerial vehicle for aerial inspection, the method comprises:
defining a list comprising at least one asset to be inspected;
acquiring structural information of the at least one asset;
defining
   at least one preliminary inspection-trajectory for the at least one asset, wherein the preliminary inspection-trajectory is based on the structural information of the at least one asset;
acquiring a map comprising at least one location for the at least one asset and geographical information of at least one region around the at least one asset;
mapping the at least one preliminary inspection-trajectory to the location of the at least one asset on the map;
altering the at least one preliminary inspection-trajectory, to accommodate a safety margin for flight of the unmanned aerial vehicle, based on the geographical information of the region around the at least one asset; and
selecting at least one altered preliminary inspection-trajectory to define the flight plan of the unmanned aerial.

In another aspect, an embodiment of the present disclosure provides a system for generating a flight plan of an unmanned aerial vehicle for aerial inspection, the system comprises:
a flight planning module operable to:
   define a list comprising at least one asset to be inspected;
   acquire structural information of the at least one asset;
   define at least one preliminary inspection-trajectory for the at least one asset, wherein the at least one preliminary inspection-trajectory is based on the structural information of the at least one asset;
   acquire a map comprising location of the at least one asset and geographical information of at least one region around the at least one asset;
   map the at least one preliminary inspection-trajectory to the location of the at least one asset on the map;
   alter the at least one preliminary inspection-trajectory, to accommodate a safety margin for flight of the unmanned aerial vehicle, based on the geographical information of the region around the at least one asset; and
   select at least one altered preliminary inspection-trajectory to define the flight plan; and
a memory unit coupled to the flight planning module.

Embodiments of the present disclosure substantially eliminate or at least partially address the aforementioned problems in the prior art, and enables generation of flight plans of unmanned aerial vehicles for aerial inspection.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A-1B are block diagrams illustrating a system for generating a flight plan of an unmanned aerial vehicle for aerial inspection, in accordance with an embodiment of the present disclosure;

FIG. 2A-2E are schematic illustrations of exemplary stages of a method for generating a flight plan of an unmanned aerial vehicle for aerial inspection, in accordance with an embodiment of the present disclosure; and

FIG. 3 is an illustration of steps of a method for generating a flight plan of an unmanned aerial vehicle for aerial inspection, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for generating a flight plan of an unmanned aerial vehicle for aerial inspection, the method comprises:
defining a list comprising at least one asset to be inspected;
acquiring structural information of the at least one asset;
defining
   at least one preliminary inspection-trajectory for the at least one asset, wherein the preliminary inspection-trajectory and the task are based on the structural information of the at least one asset;
acquiring a map comprising at least one location for the at least one asset and geographical information of at least one region around the at least one asset;
mapping the at least one preliminary inspection-trajectory to the location of the at least one asset on the map;
altering the at least one preliminary inspection-trajectory, to accommodate a safety margin for flight of the unmanned aerial vehicle, based on the geographical information of the region around the at least one asset; and
selecting at least one altered preliminary inspection-trajectory to define the flight plan of the unmanned aerial vehicle to perform the at least one task along the at least one altered preliminary inspection-trajectory.

In another aspect, an embodiment of the present disclosure provides a system for generating a flight plan of an unmanned aerial vehicle for aerial inspection, the system comprises:
a flight planning module operable to:
   define a list comprising at least one asset to be inspected;
   acquire structural information of the at least one asset;
   define at least one preliminary inspection-trajectory for the at least one asset, wherein the at least one preliminary inspection-trajectory is based on the structural information of the at least one asset;
   acquire a map comprising location of the at least one asset and geographical information of at least one region around the at least one asset;
   map the at least one preliminary inspection-trajectory to the location of the at least one asset on the map;
   alter the at least one preliminary inspection-trajectory, to accommodate a safety margin for flight of the unmanned aerial vehicle, based on the geographical information of the region around the at least one asset; and
   select at least one altered preliminary inspection-trajectory to define the flight plan of the unmanned aerial vehicle; and
a memory unit coupled to the flight planning module.

The present disclosure provides a method and system for generating a flight plan of an unmanned aerial vehicle for aerial inspection. The method enables generation of flight plan comprising an optimized flight trajectory for performing inspection of an asset, thereby reducing time of flight, distance of travel and power consumption of the unmanned aerial vehicle. Further, tasks to be performed for inspection of the asset are incorporated into the flight plan, eliminating a requirement of performing additional flights and leading to shorter project completion time, reduced fuel costs, and so forth. The method also accommodates a safety margin for flight of the unmanned aerial vehicle, thereby avoiding a risk of collision with objects in proximity of the asset and ensuring safe and reliable operation of the unmanned aerial vehicle during asset inspection.

In one embodiment, the unmanned aerial vehicle (or UAV) may be an aircraft without human pilots and/or passengers onboard. Further, the UAV may be operated fully or partially autonomously for real world applications (or missions), using on-board computers or remotely located human operators. For example, the UAV may be used for missions such as aerial photography, aerial surveillance, aerial inspection, aerial video, aerial measurements, aerial remote sensing and so forth.

In an embodiment, the flight plan for the UAV may include information related to a mission of the UAV. The flight plan may be prepared prior to flight of the UAV and the UAV may be operated in accordance with the flight plan. It may be evident that due to absence of humans onboard, adherence to the flight plan for the UAV may be critical to success of the mission of the unmanned aerial vehicle.

The method comprises defining a list comprising at least one asset to be inspected. The list may include information about one or multiple assets to be inspected by the unmanned aerial vehicle. In an example, the list may be an ordered list of assets that are arranged based in a decreasing (or increasing) order of importance of the assets to be inspected first. In another example, the list may be an unordered (or random) list of assets to be inspected. In another example, the list may be divided to multiple unmanned aerial vehicles in accordance with some criteria, for example geographical proximity of assets.

In one embodiment, the asset is one of a building, a manufacturing setup, a distribution setup, and a vegetation field. In an example, the asset may be a building that may include residential structures, roads, filling stations, bridges, offices, commercial establishments (such as shopping malls and theme parks) and so forth. In another example, the asset may include a manufacturing setup, such as a factory, production plants, construction sites, mines, and so forth. In yet another example, the asset may include a distribution setup, such as fuel distribution lines, power lines, electricity pylons, water supply systems, drainage systems, and so forth. In yet another example, the asset may include a agricultural field such as an apple garden or a paddy field.

The method further comprises acquiring structural information of the at least one asset. The method also comprises defining at least one preliminary inspection-trajectory for the at least one asset. The preliminary inspection-trajectory is based on the structural information of the at least one asset.

According to an embodiment, the structural information of the at least one asset may comprise information such as type of asset, shape of the asset, a material of structure of the asset (such as steel or concrete), components of the asset (such as information about number of fuel pumps at a filling station), empty spaces of the asset, and so forth. For example, the structural information of the at least one asset comprises geometrical measurement data of the at least one asset based on which the preliminary inspection-trajectory is defined. Specifically, the geometrical measurement data may include information associated with length, width, height, diameter, angle of inclination (at different points), and so forth of the asset.

In another embodiment, the structural information of the at least asset may comprise information of the age of components of the asset, the suggested maintenance period of the asset or any component thereof, and other information related to the need of inspection of any component of the asset.

In an embodiment, a preliminary inspection-trajectory for the asset may correspond to a flight trajectory of an UAV around the asset. The preliminary inspection-trajectory may be defined for the UAV based on the structural information of the asset. In an example, a preliminary inspection-trajectory for inspection of an electricity pylon may be defined based on an angle of inclination at various heights on the electricity pylon. In another example, preliminary inspection-trajectory of the UAV for inspection of a building may be defined based on the length, width and height of the building, and may correspond to a flight route that the UAV may be configured to fly along to inspect the building. In an example, a preliminary inspection-trajectory for inspection of a water distribution system may be defined based on a diameter of one or more pipes associated with the water distribution system.

In one embodiment, the at least one preliminary inspection-trajectory may comprise a spiral-trajectory, a circular-trajectory, a straight-trajectory, a zigzag-trajectory, a random-trajectory and any combination thereof. For example, a preliminary inspection-trajectory for inspecting deck of a bridge may comprise a straight-trajectory (horizontal) along the length of the bridge. In another example, a preliminary inspection-trajectory for inspecting a vegetation field may comprise a zigzag-trajectory along length and width of the field. In yet another example, a preliminary inspection-trajectory for inspecting an electricity pylon may comprise a spiral-trajectory (or circular-trajectory) around the electricity pylon.

According to an embodiment, the structural information of the at least one asset may also comprise critical attribute data of the at least one asset based on which the task to be performed is defined. In an example, the critical attribute data of an asset may be associated with critical structural or functional elements (of the asset), which may be the area of interest and accordingly needs to be inspected for the asset inspection. For example, the critical element of a suspension bridge may include suspension cables, on which structure of the bridge may be suspended. In another example, the critical element of an electricity pylon may include insulators or an aircraft warning light mounted on the pylon.

In an embodiment, the task to be performed by the UAV along the at least one preliminary inspection-trajectory is based on the structural information of the at least one asset. For example, the task may include at least one action to be executed by the UAV along the preliminary inspection-trajectory around the asset that may enable inspection of critical elements of the asset. Further, the task performed by the UAV may depend on the structural information of the asset, for example, the task may be performed by the UAV at specific points (associated with critical elements) along the preliminary inspection-trajectory for the inspection thereof. Further, the task performed by the UAV may include at least one of the location of the UAV at each of the time of data collection, the direction of the UAV at the time of data collection, and the direction of at least one of a sensor attached to the UAV. In one embodiment, the tasks comprise collecting at least one of a photo, a video and sensor data based on the critical attribute data of the at least one asset. For example, the unmanned aerial vehicle may be operable to capture photos of insulators of an electricity pylon to enable inspection of the electricity pylon. In another example, the unmanned aerial vehicle may be operable to collect sensor data, such as corona detector data, of power lines to enable in detection of corona discharge from the power lines. It may be evident that tasks performed at specific points (i.e. based on the critical attribute data) along the preliminary inspection-trajectory may enable reduced power consumption of the UAV and may further enable the unmanned aerial vehicle to stay in flight for longer duration of time. The task may involve the use of other sensors, like biosensors for monitoring gas leaks, magnetometers for measuring magnetic field, electric potential sensors for measuring electric potential and so on.

The method comprises acquiring a map comprising at least one location of the at least one asset and geographical information of at least one region around the at least one asset. The map may be acquired to determine the real-world locations of the assets to be inspected during preparation of the flight plan. It may be evident that the map may comprise information of the locations of the assets and the geographical information of the regions around the assets. For example, a map may comprise locations of electricity pylons in a city and the geographical information of the regions around the assets may comprise information of landscape, structures, vegetation and so forth located around the electricity pylons.

In an embodiment, the map is a digital surface model generated using Light Detection and Ranging (LiDAR) data. The digital surface model may be a representation of elevation data of region comprising the at least one asset. Further, the digital surface model may comprise elevation of surface of earth along with elevation of natural or man-made objects, such as mountains, buildings, and so forth. For example, a digital surface model of a region comprising a bridge may include elevation of the bridge and elevation of mountains, trees and roads present in the region around the bridge.

In an embodiment, point cloud data acquired using airborne LiDAR systems may be used for generating the digital surface model. In another embodiment, point cloud data acquired using ground-based mobile or vehicle-mounted LiDAR systems may be used for generating the digital surface model. The point cloud data relates to a collection of data points, such as three-dimensional coordinates of external surfaces of objects. It may be evident that the map (or the digital surface model) may be acquired prior to preparation of the flight plan. Optionally, the digital surface model may be generated using, but is not limited to, stereo camera data, asset geometry data, and microwave radar scanner data. In one embodiment, the map may be acquired using a third-party service.

In one embodiment, the location of the at least one asset comprises latitude, longitude and altitude coordinates of the at least one asset.

The method further comprises mapping the at least one preliminary inspection-trajectory to the location of the at least one asset on the map. The preliminary inspection-trajectory defined for the at least one asset may be associated to the location of the at least one asset on the map. Therefore, the map may include the preliminary inspection-trajectory, mapped to the location of the at least one asset. It may be evident that a map may comprise multiple preliminary inspection-trajectories mapped to locations of multiple assets. For example, a map may comprise spiral-trajectories mapped to predetermined locations of 10 electricity pylons.

The method further comprises altering the at least one preliminary inspection-trajectory, to accommodate a safety margin for flight of the unmanned aerial vehicle, based on the geographical information of the region around the at least one asset. The geographical information of the region around the at least one asset comprises information of objects in close proximity of the at least one asset. The geographical information may be used to alter the preliminary inspection-trajectory for flight of the unmanned aerial vehicle around the asset. Further, the safety margin for flight of the unmanned aerial vehicle may include considerations such as a safe flying distance. The safe flying distance may be a minimum distance of separation between the UAV and objects along the flight route of the unmanned aerial vehicle. In an example, the safe flying distance may be determined using the digital surface model of the location of the at least one asset. In another example, the safe flying distance may be a default pre-determined distance. It may be evident that the unmanned aerial vehicle may be required to maintain the safe flying distance for avoiding collision with nearby objects.

According to an embodiment, the at least one preliminary inspection-trajectory may be further altered based on weather condition of the location of the at least one asset. The weather condition of the location of the at least one asset may affect the unmanned aerial vehicle and/or the flight route thereof. For example, such weather conditions may include thunderstorms, strong winds, snowfall and so forth. For example, the preliminary inspection-trajectory of the unmanned aerial vehicle may be altered if a strong wind develops within the locations of the at least one asset. Further, the weather condition may be acquired from a server of a climate data centre.

In an embodiment, the at least one preliminary inspection-trajectory may be altered based on operating capability of the unmanned aerial vehicle. The operating capabilities of the UAV may affect operation thereof. Examples of such operating capabilities include, but are not limited to, weight, material, and trust-to-weight ratio of UAV, and the accuracy and reliability of the UAV's positioning system. In an example, a lightweight unmanned aerial vehicle may not be able to withstand strong winds in the region. Therefore, preliminary inspection-trajectory of the lightweight unmanned aerial vehicle may be altered accordingly.

In an embodiment, the at least one preliminary inspection-trajectory is further altered based on quality of the geographical information of regions around the at least one asset. The geographical information of regions obtained from a map may depend on quality of the LiDAR data that is used to generate the digital surface model. Further, quality of the LiDAR data may depend on a variety of parameters such as age of the LiDAR data, density of the point cloud data, and distance between the airborne LiDAR systems and the locations of the at least one asset. Specifically, the safe flying distance may be inversely related to the age of the LIDAR data. For example, the safe flying distance may be 100 feet if the LIDAR data is 3 years old, and may be 30 feet if the LIDAR data is 1 month old.

The method also comprises selecting at least one altered preliminary inspection-trajectory to define the flight plan of the unmanned aerial vehicle to perform the at least one task along the at least one altered preliminary inspection-trajectory. The flight plan is defined using the altered preliminary inspection-trajectory for inspection of the at least one asset and may comprise a starting point and an ending point for a flight of the unmanned aerial vehicle. In an example, the starting point for the flight of the unmanned aerial vehicle may be same as the ending point, such as a ground control station. In an embodiment, multiple altered preliminary inspection-trajectories for inspection of multiple assets may be combined to define a flight plan for an unmanned aerial vehicle. Further, a flight of the unmanned aerial vehicle may be executed based on such flight plan.

In an embodiment, the method comprises optimizing the preliminary inspection-trajectory based on at least one of a shortest distance of travel for the unmanned aerial vehicle, a shortest time taken for travel for the unmanned aerial vehicle, and least power consumption for travel for the unmanned aerial vehicle. In an example, the preliminary inspection-trajectory may be optimized based on travelling salesman problem (TSP) algorithm wherein the unmanned aerial vehicle may be configured to follow a shortest distance of travel for the unmanned aerial vehicle with a further consideration of having performed each task associated with a critical element of the asset only once.

The system for generating a flight plan of an unmanned aerial vehicle for aerial inspection comprises a flight planning module. The flight planning module may be operable to generate the flight plan of the unmanned aerial vehicle. Further, the flight planning module may include hardware, software, firmware, or combination of these, suitable for generating the flight plan of the unmanned aerial vehicle. The flight planning module may comprise a processing unit, random access memory, persistent memory, data bus, input/output channels and so forth.

The flight planning module is operable to define a list comprising at least one asset to be inspected. In an example, the flight planning module may be provided with an input including multiple assets to be inspected and the flight planning module may prepare a list having the assets. In another example, the flight planning module may be provided with an order of importance of the assets to be inspected first and the flight planning module may be operable to prepare the list in accordance with the order of importance (such as a list with the assets arranged in an increasing or decreasing order of importance). In yet another example, the flight planning module may be provided access to (or make available for use) a previously generated list having at least one asset to be inspected.

The flight planning module is further operable to acquire structural information of the at least one asset. In an example, the structural information of the at least one asset may be acquired from pre-existing documentation, such as construction plans or blueprints. In another example, the structural information of the at least one asset may be acquired from a previous flight of an unmanned aerial vehicle. In yet another example, the structural information of the at least one asset may be acquired using a third party service. In yet another example, the structural information of the at least one asset may be estimated for example based on visual observation of the asset.

The flight planning module is further operable to define at least one preliminary inspection-trajectory for the at least one asset and at least one task to be performed by the unmanned aerial vehicle along the at least one preliminary inspection-trajectory. The preliminary inspection-trajectory and the task are based on the structural information of the at least one asset. For example, the flight planning module may be operable to prepare a preliminary inspection-trajectory having a predetermined shape (such as a spiral-trajectory, a circular-trajectory, a straight-trajectory, a zigzag-trajectory) based on geometrical measurement data (such as height and width) of the at least one asset. Further, the flight planning module may be operable to define the task based on critical attribute data of the at least one asset.

In an example, the task such as capturing of photos of insulators of an electricity pylon may be defined by the flight planning module in accordance with the position of the insulators relative to height of the electricity pylon. In such instance, photos of multiple insulators may be captured at same height on the electricity pylon in accordance with positioning of multiple insulators at the same height on the electricity pylon.

In one embodiment, the preliminary inspection-trajectory may further comprise speed of the unmanned aerial vehicle. For example, the preliminary inspection-trajectory for inspection of a building may include a circular or spiral-trajectory of the unmanned aerial vehicle around the building at a speed of 40 knots.

The flight planning module is also operable to acquire a map comprising at least one location of the at least one asset and geographical information of at least one region around the at least one asset. In an example, the map may be acquired from a database comprising digital surface model of the at least one location comprising the at least one asset. In another example, the map may be acquired using a third party service.

The flight planning module is operable to map the at least one preliminary inspection-trajectory to the location of the at least one asset on the map. In an example, the flight planning module may be provided with the locations (such as latitude, longitude and altitude coordinates) of the at least one asset, and the flight planning module may be operable to map (or plot) the preliminary inspection-trajectory for the at least one asset on such locations.

The flight planning module is further operable to alter the at least one preliminary inspection-trajectory, to accommodate a safety margin for flight of the unmanned aerial vehicle, based on the geographical information of the region around the at least one asset. The flight planning module may be operable to calculate the safety margin for the unmanned aerial vehicle based on geographical information of the region around the at least one asset. Specifically, the flight planning module may use information of objects in proximity of the at least one asset to define the safety margin. For example, a circular preliminary inspection-trajectory of diameter 100 feet around a building may be altered to include a safety margin of 30 feet based on other buildings or trees in the proximity of the building. In such instance, the circular preliminary inspection-trajectory of diameter 100 feet around the building may be altered to a circular preliminary inspection-trajectory of diameter 90 feet around the building. In another instance, the circular preliminary inspection-trajectory of diameter 100 feet around the building may be altered to a circular preliminary inspection-trajectory of diameter 120 feet around the building.

The flight planning module is also operable to select at least one altered preliminary inspection-trajectory to define the flight plan of the unmanned aerial vehicle to perform the at least one task along the at least one altered preliminary inspection-trajectory. The flight planning module may be operable to select at least one altered preliminary inspection-trajectory and prepare the flight plan by defining parameters (such as speed and route) for flight of the unmanned aerial vehicle. In an example, the flight planning module may be operable to generate a flight plan using a starting point, an altered preliminary inspection-trajectory and an ending point for flight of an unmanned aerial vehicle. In another example, the flight planning module may be operable to calculate a shortest distance of flight between multiple assets to be inspected and define a flight plan.

The system further comprises a memory unit coupled to the flight planning module. In an embodiment, the memory unit is configured to store information associated with at least one of the list, the structural information, the preliminary inspection-trajectory, the task to be performed by the unmanned aerial vehicle, the map, the geographical information of the region, the safety margin, the altered preliminary inspection-trajectory, and the flight plan.

According to an embodiment, the unmanned aerial vehicle comprises the flight planning module and the memory unit. In one embodiment, the system further comprises a ground control station communicably coupled to the unmanned aerial vehicle, and the ground control station comprises the flight planning module and the memory unit.

According to an embodiment, the unmanned aerial vehicle may comprise at least one sensor coupled to the flight planning module. Specifically, the at least one sensor may be a part of payload of the unmanned aerial vehicle. Further, the at least one sensor may be used for missions to be executed by the unmanned aerial vehicle. In an embodiment, the at least one sensor may be one of an image sensor, a proximity sensor, a distance sensor, a motion sensor, an electromagnetic sensor and a biosensor. It may be evident that the at least one sensor may further include, but is not limited to a radiation sensor and an infrared sensor. For example, if an unmanned aerial vehicle is operated for aerial inspection of a mountainous region, digital cameras comprising image sensors may be attached to the unmanned aerial vehicle, and coupled to the flight planning module.

### DETAILED DESCRIPTION OF THE DRAWINGS

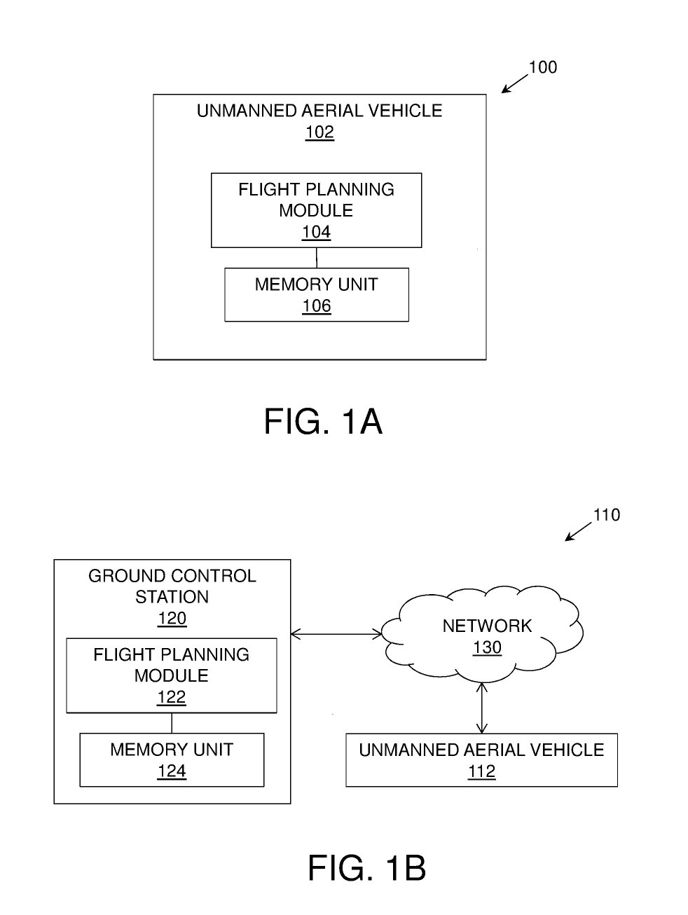

FIG. 1A is a block diagram illustrating a system 100 for generating a flight plan of an unmanned aerial vehicle 102 for aerial inspection, in accordance with an embodiment of the present disclosure. As shown, the unmanned aerial vehicle 102 comprises a flight planning module 104 and a memory unit 106 coupled to the flight planning module 104.

FIG. 1B is a block diagram illustrating a system 110 for generating a flight plan of an unmanned aerial vehicle 112 for aerial inspection, in accordance with another embodiment of the present disclosure. As shown, the system 110 comprises a ground control station 120 communicably coupled to the unmanned aerial vehicle 112 via a network 130. The ground control station 120 comprises a flight planning module 122 and a memory unit 124 coupled to the flight planning module 122.

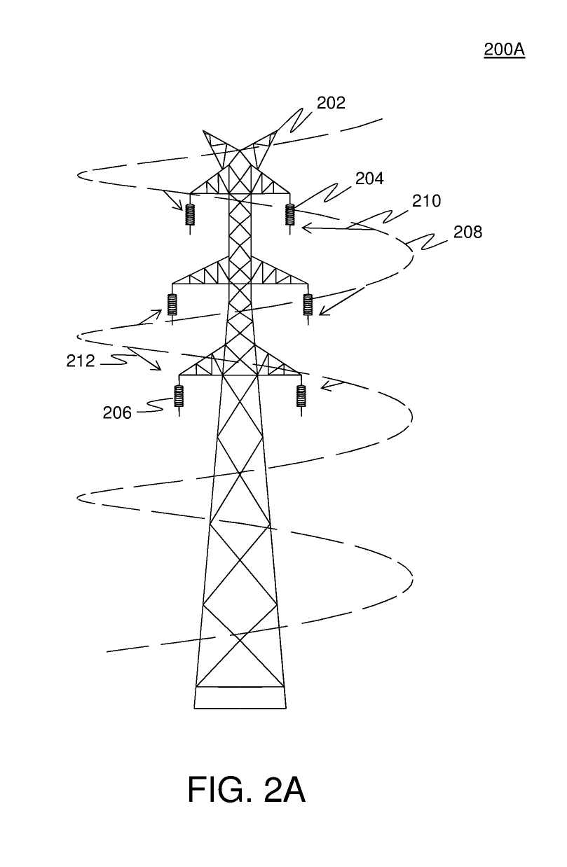

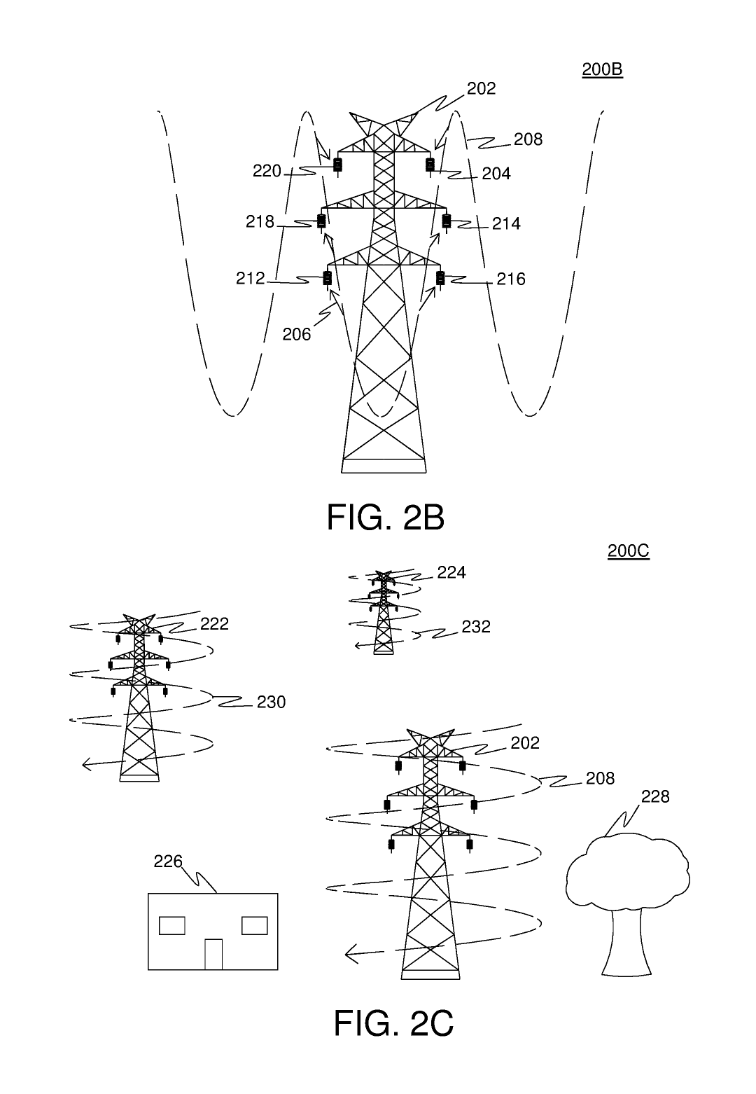

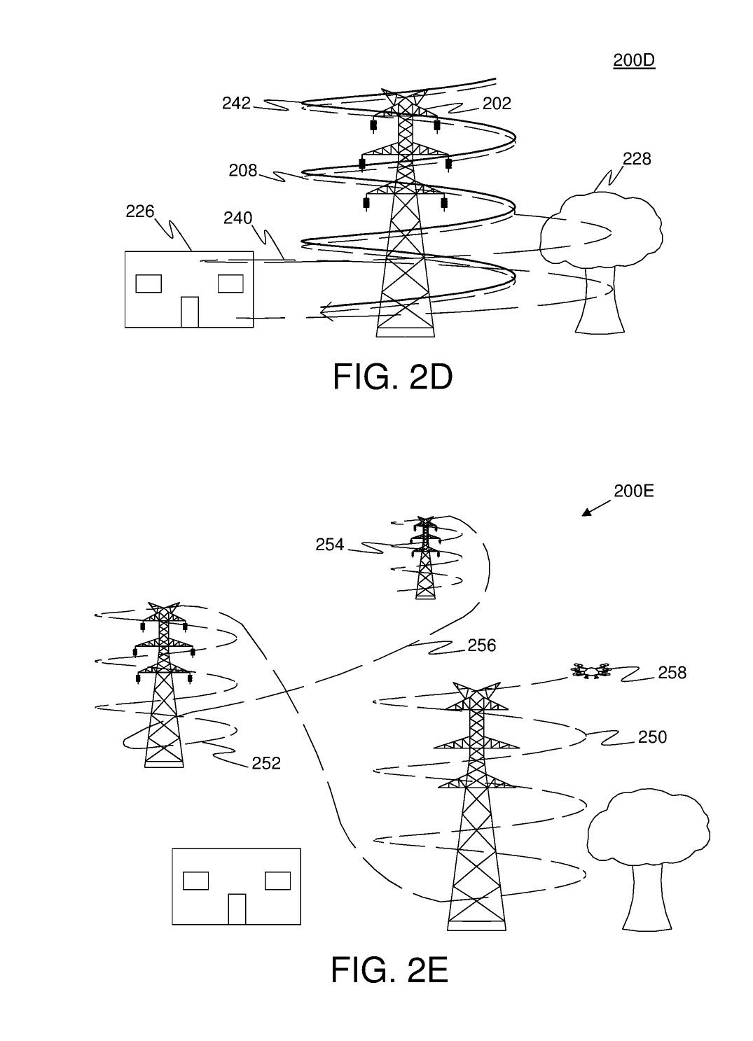

FIG. 2A-2E are schematic illustrations of exemplary stages of a method for generating a flight plan of an unmanned aerial vehicle for aerial inspection, in accordance with an embodiment of the present disclosure.

FIG. 2A is an illustration of a stage 200A of a method for generating a flight plan of an unmanned aerial vehicle for aerial inspection, in accordance with an embodiment of the present disclosure. As shown, a preliminary inspection-trajectory 208 is defined for an asset 202, and the preliminary inspection-trajectory 208 comprises a vertical spiral-trajectory. The asset 202 comprises critical elements such as 204 and 206. Further, tasks 210 and 212 (such as triggering of sensors to collect data) to be performed by the unmanned aerial vehicle (not shown) along the at least one preliminary inspection-trajectory 208 are defined based on structural information of the asset 202.

FIG. 2B is an illustration of an alternative embodiment of the stage 200B of a method for generating a flight plan of an unmanned aerial vehicle for aerial inspection, in accordance with an embodiment of the present disclosure. As shown, a preliminary inspection-trajectory 208 comprises a horizontal spiral-trajectory around the asset 202. In such instance, the unmanned aerial vehicle (not shown) is configured to approach the asset 202 on one side of the asset and perform task 210 to collect data associated with the topmost critical attribute 204 on that side of the asset 202. Further, the unmanned aerial vehicle is configured to decrease altitude to perform tasks to collect data associated with the other critical elements such as 214 and 216 on the same side of the asset 202. Subsequently, the unmanned aerial vehicle is configured to increase altitude to approach the opposite side of the asset 202 and perform task 212 to collect critical attribute data associated with the lowermost critical attribute 206. Further, the unmanned aerial vehicle is configured to increase altitude to perform tasks to collect data associated with the other critical elements such as 214 and 216 on the same side of the asset 202.

FIG. 2C is an illustration of another stage 200C of a method for generating a flight plan of an unmanned aerial vehicle for aerial inspection, in accordance with an embodiment of the present disclosure.

As shown, assets 202, 222 and 224 are located in region also comprising a building 226 and a tree 228. Preliminary inspection-trajectories 208, 230 and 232 are mapped to locations of the assets 202, 222 and 224 in the region.

FIG. 2D is an illustration of yet another stage 200D of a method for generating a flight plan of an unmanned aerial vehicle for aerial inspection, in accordance with an embodiment of the present disclosure. The preliminary inspection-trajectory 208 for asset 202 is altered to accommodate safety margin for flight of an unmanned aerial vehicle. As shown, altered preliminary inspection-trajectory 240 violates the safety margin as the inspection-trajectory is obstructed by objects such as the building 226 and the tree 228. Consequently, the altered preliminary inspection-trajectory 240 is not accepted. Further, altered preliminary inspection-trajectory 242 is shown to include the safety margin as the inspection-trajectory is not obstructed by any other objects. Therefore, the altered preliminary inspection-trajectory 242 is accepted to be accommodating of the safety margin for flight on the unmanned aerial vehicle.

FIG. 2E is an illustration of yet another stage 200E of a method for generating a flight plan of an unmanned aerial vehicle for aerial inspection, in accordance with an embodiment of the present disclosure. As shown, altered preliminary inspection-trajectories 250, 252, and 254 are selected to define a flight plan 256 of an unmanned aerial vehicle 258.

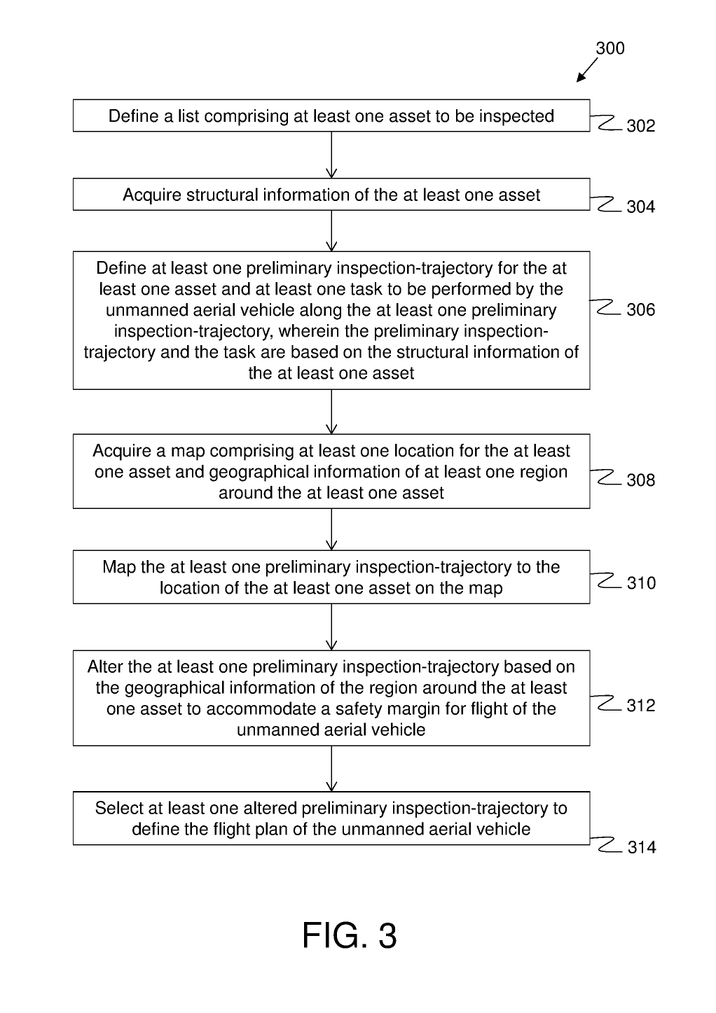

FIG. 3 is an illustration of steps of a method 300 for generating a flight plan of an unmanned aerial vehicle for aerial inspection, in accordance with an embodiment of the present disclosure. At step 302, a list comprising at least one asset to be inspected is defined. At step 304, structural information of the at least one asset is acquired. At step 306, at least one preliminary inspection-trajectory for the at least one asset and at least one task to be performed by the unmanned aerial vehicle along the at least one preliminary inspection-trajectory is defined, wherein the preliminary inspection-trajectory and the task are based on the structural information of the at least one asset. At step 308, a map comprising at least one location for the at least one asset and geographical information of at least one region around the at least one asset is acquired. At step 310, the at least one preliminary inspection-trajectory is mapped to the location of the at least one asset on the map. At step 312, the at least one preliminary inspection-trajectory is altered based on the geographical information of the region around the at least one asset to accommodate a safety margin for flight of the unmanned aerial vehicle. At step 314, at least one altered preliminary inspection-trajectory is selected to define the flight plan of the unmanned aerial vehicle.

The steps 302 to 314 are only illustrative and other alternatives can also be provided where one or more steps are added, one or more steps are removed, or one or more steps are provided in a different sequence without departing from the scope of the claims herein. For example, the method 300 may further comprise a step of altering the preliminary inspection-trajectory based on one of weather condition of the locations of the at least one asset, operating capabilities of the unmanned aerial vehicle, and quality of the geographical information of regions around the at least one asset. Optionally, in the method 300 the locations of the at least one asset may comprise latitude, longitude and altitude coordinates of the at least one asset. In another example, the method 300 may further comprise a step of optimizing the preliminary inspection-trajectory based on at least one of a shortest distance travel for the unmanned aerial vehicle, a shortest time taken for travel for the unmanned aerial vehicle, and least power consumption for travel for the unmanned aerial vehicle. Optionally, in the method 300 the structural information of the at least one asset may comprise geometrical measurement data of the at least one asset based on which the preliminary inspection-trajectory is defined, and critical attribute data of the at least one asset based on which the tasks to be performed is defined. Also, in the method 300 the tasks may comprise collecting one of photos, videos, and sensor data associated with the critical attribute of the at least one asset. Moreover, in the method 300, the at least one preliminary inspection-trajectory may comprise a spiral-trajectory, a circular-trajectory, a straight-trajectory, a zigzag-trajectory, a random-trajectory and any combination thereof. Further, in the method 300, the asset may be one of a building, a manufacturing setup, a distribution setup, and a vegetation field. Furthermore, in the method 300, the map may be a digital surface model generated using Light Detection and Ranging (LiDAR) data.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for generating a flight plan of an unmanned aerial vehicle for aerial inspection, the method comprising:
defining a list comprising at least one asset to be inspected;
acquiring structural information of the at least one asset;
defining
at least one preliminary inspection-trajectory for the at least one asset,
wherein the preliminary inspection-trajectory is based on the structural information of the at least one asset;
acquiring a map comprising at least one location for the at least one asset and geographical information of at least one region around the at least one asset;
mapping the at least one preliminary inspection-trajectory to the location of the at least one asset on the map;
altering the at least one preliminary inspection-trajectory, to accommodate a safety margin for flight of the unmanned aerial vehicle, based on the geographical information of the region around the at least one asset; and
selecting at least one altered preliminary inspection-trajectory to define the flight plan of the unmanned aerial vehicle.

2. A method according to claim 1, wherein the defining at least one preliminary inspection-trajectory further comprises of
defining at least one task to be performed by the unmanned aerial vehicle in at least one point in the at least one preliminary inspection-trajectory based on the structural information of the at least one asset.

3. A method according to claim 1, wherein the at least one preliminary inspection-trajectory is further altered based on at least one of
weather condition of the location of the at least one asset;
operating capability of the unmanned aerial vehicle; and
quality of the geographical information of the region around the at least one asset.

4. A method according to claim 1, wherein the location of the at least one asset comprises latitude, longitude, and altitude coordinates of the at least one asset.

5. A method according to claim 1, further comprising optimizing the preliminary inspection-trajectory based on at least one of a shortest distance of travel for the unmanned aerial vehicle, a shortest time taken for travel for the unmanned aerial vehicle, and least power consumption for travel of the unmanned aerial vehicle.

6. A method according to claim 1, wherein the structural information of the at least one asset comprises:
geometrical measurement data of the at least one asset based on which the preliminary inspection-trajectory is defined; and
critical attribute data of the at least one asset based on which the task to be performed is defined.

7. A method according to claim 6, wherein the defining at least one preliminary inspection-trajectory further comprises of
defining at least one task to be performed by the unmanned aerial vehicle in at least one point in the at least one preliminary inspection-trajectory based on the structural information of the at least one asset and the task comprises collecting at least one of a photo, a video and a sensor data based on the critical attribute data of the at least one asset.

8. A method according to claim 1, wherein the at least one preliminary inspection-trajectory comprises a spiral-trajectory, a circular-trajectory, a straight-trajectory, a zigzag-trajectory, a random-trajectory and any combination thereof.

9. A method according to claim 1, wherein the asset is one of a building, a manufacturing setup, a distribution setup, and an agricultural field.

10. A method according to claim 1, wherein the map is a digital surface model generated using Light Detection and Ranging data.

11. A system for generating a flight plan of an unmanned aerial vehicle for aerial inspection, the system comprising:
a flight planning module operable to:
define a list comprising at least one asset to be inspected;
acquire structural information of the at least one asset;
define at least one preliminary inspection-trajectory for the at least one asset by the unmanned aerial vehicle, wherein the at least one preliminary inspection-trajectory is based on the structural information of the at least one asset;
acquire a map comprising location of the at least one asset and geographical information of at least one region around the at least one asset;
map the at least one preliminary inspection-trajectory to the location of the at least one asset on the map;
alter the at least one preliminary inspection-trajectory, to accommodate a safety margin for flight of the unmanned aerial vehicle, based on the geographical information of the region around the at least one asset; and
select at least one altered preliminary inspection-trajectory to define the flight plan of the unmanned aerial vehicle; and
a memory unit coupled to the flight planning module.

12. A system according to claim 11, wherein the unmanned aerial vehicle comprises the flight planning module and the memory unit.

13. A system according to claim 11, further comprising a ground control station communicably coupled to the unmanned aerial vehicle, wherein the ground control station comprises the flight planning module and the memory unit.

14. A system according to claim 11, wherein the unmanned aerial vehicle comprises at least one sensor coupled to the flight planning module.

15. A system according to the claim 14, wherein the at least one sensor is one of an image sensor, a proximity sensor, a distance sensor, a motion sensor, an electromagnetic sensor and a biosensor.

16. A system according to claim 11, wherein the memory unit is configured to store information associated with at least one of the list, the structural information, the preliminary inspection-trajectory, the map, the geographical information of the region, the safety margin, the altered preliminary inspection-trajectory and the flight plan.
